(19) United States
(12) Patent Application Publication
(10) Pub. No.: US 2005/0238088 A1
(43) Pub. Date: Oct. 27, 2005

(54) Wireless communication system

(76) Inventors: Bill Piepmeyer, Louisville, KY (US); Wayne Crabb, Patterson, GA (US); Ronald Ham, Nahunta, GA (US); Clay Wilson, Waycross, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/100,646

(22) Filed: Apr. 7, 2005

Related U.S. Application Data
(60) Provisional application No. 60/560,469, filed on Apr. 7, 2004.

(51) Int. Cl. H04B 1/38

(52) U.S. Cl. 375/222

(57) ABSTRACT

Embodiments of the present disclosure provide systems and methods for implementing a wireless communication system. Briefly described, in architecture, one embodiment of the system, among others, includes a receiving antenna that receives data signals from a base station. The wireless modem is positioned on the receiving antenna and receives data signals from the receiving antenna. Then, the wireless modem communicates information contained in the data signals to a remote data communications device, such as a general purpose computer. Other systems and methods are provided.

### CROSS-REFERENCE TO RELATED APPLICATION

This application claims priority to copending U.S. provisional application entitled, “A Wireless Communication System,” having Ser. No. 60/560,469, filed Apr. 7, 2004, which is entirely incorporated herein by reference.

### TECHNICAL FIELD

The present invention is generally related to communications and, more particularly, is related to wireless data communications.

### BACKGROUND

A “modem” refers to a device that modulates an analog “carrier” signal (such as sound), to encode digital information, and that also demodulates such a carrier signal to decode the transmitted information. The goal is to produce a signal that can be transmitted easily and decoded to reproduce the original digital data. Originally used to communicate via telephone lines, modems can be used over any means of transmitting analog signals, from driven diodes to radio. As such, wireless modems are often used to access wireless computer networks. However, wireless modems are limited by current technological implementations. Thus, a heretofore unaddressed need exists in the industry to address the aforementioned deficiencies and inadequacies.

### SUMMARY

Embodiments of the present disclosure provide systems and methods for implementing a wireless communication system. Briefly described, in architecture, one embodiment of the system, among others, includes a receiving antenna that receives data signals from a base station. The wireless modem is positioned on the receiving antenna and receives data signals from the receiving antenna. Then, the wireless modem communicates information contained in the data signals to a remote data communications device, such as a general purpose computer.

Embodiments of the present disclosure can also be viewed as providing methods for implementing a wireless communication system. In this regard, one embodiment of such a method, among others, can be broadly summarized by the following steps: directly connecting a wireless modem to a receiving antenna, the receiving antenna and the wireless modem co-located in an outdoor environment; and coupling the wireless modem to a data communication device, where the data communication device is positioned remotely from the receiving antenna and the wireless modem.

Other systems, methods, features, and advantages of the present disclosure will be or become apparent to one with skill in the art upon examination of the following drawings and detailed description. It is intended that all such additional systems, methods, features, and advantages be included within this description, and be within the scope of the present disclosure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of one embodiment for implementing a wireless communication system according to the present disclosure.

FIG. 2 is a block diagram of one embodiment for implementing a wireless modem according to FIG. 1.

FIG. 3 is a block diagram of an assembly for one embodiment of the wireless modem of FIG. 2.

FIGS. 4A-4B are tables showing a cost comparison between an installation of a standard wireless communication system and an installation of an embodiment of the wireless communication system of FIG. 1.

FIG. 5 is a diagram representation showing the increased range of a base terminal station that is achieved by utilizing the system of FIGS. 1-3.

FIG. 6 is a flowchart describing one embodiment of a method for implementing the wireless modem of FIG. 3.

### DETAILED DESCRIPTION

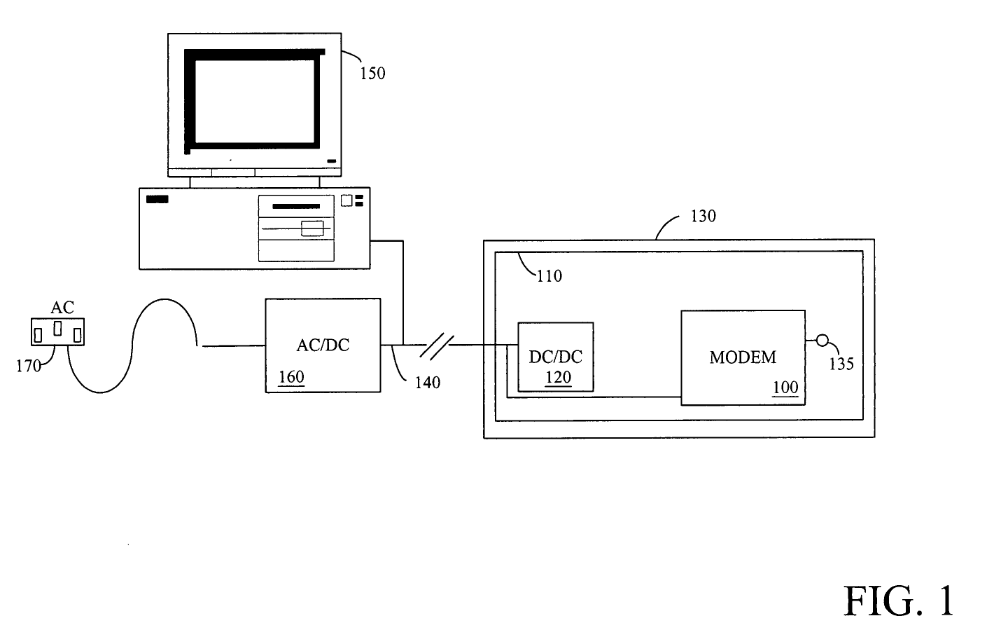

FIG. 1 is a block diagram of one embodiment for implementing a wireless communication system according to the present disclosure. As shown in FIG. 1, modem card 100 is contained within a protective enclosure 110. The protective enclosure 110, for some embodiments, is preferably a metal box or other type of metal enclosure. Also included within the protective enclosure 110, a DC/DC converter 120 is connected to the DC power connector of the modem card 100. The DC/DC converter 120 converts DC voltage received from a power source to a lower voltage and a stated current that meets stated voltage and current specifications of the modem card 110. For example, in some embodiments, a voltage of 5 volts (at 8 amps) is preferred for the modem card 110. Therefore, a DC/DC converter 120 that accepts a 36-76 Volt DC input and produces a 5 Volt (8 amps) output is used.

The modem card 110 is also directly connected to an antenna 130 (located at a customer premise) that receives wireless transmissions from a base terminal station (BTS) 180 (also generally referred to as a base access point). The antenna 130 may take a variety of forms to be compatible and operable with technology employed at the BTS 180. For example, in different embodiments, the antenna 130 may take a parabolic shape, a panel shape, etc. Further, the antenna 130 may be configured to receive certain frequency bands (such as 2.3 GHz, 2.4 GHz, 2.5 GHz, 2.6 GHz, etc., of which some are regulated by the Federal Communications Commission (FCC), for example).

Accordingly, the modem card 100 also may encompass many different types and varieties depending on the corresponding technology (whether proprietary or not) employed at the BTS 180. Therefore, the present disclosure is not meant to be limited to the specific examples and embodiments discussed herein. To connect the modem card 100 to the antenna 130, a connector 135 may be provided inside the metal enclosure 110 to connect the modem card 100 directly to the antenna 130. Thus a short cable or jumper is used, in some embodiments, to connect the antenna connection on the modem card 100 to the external antenna 130. The protective enclosure 110 is then attached to the backside of the antenna 130 (via screws, bolts, adhesive, metal weld, etc.). Alternatively, the protective enclosure, in some embodiments, is manufactured as part of the antenna 130. Typically, the antenna 130 is placed on top of an antenna tower (at a distance of 40 feet from the ground, for example) to improve reception of transmissions from the BTS 180. Therefore, in such embodiments, the protective enclosure 110 and its contents are also secured on top of the antenna tower with the antenna 130. By directly connecting the modem card 100 to the antenna 130, any potential signal loss from the antenna to the modem card 100 via cable signal loss is avoided.

Consider, in other standard or traditional wireless modem configurations, an internal or external modem is typically connected to the antenna by 50 to 100 feet of network, data, or RF cable. In such configurations, the signal from the antenna (located at the customer premise) is attenuated as it propagates through the length of the cable. Therefore, the strength of the signal is severely weakened by the time the internal/external modem receives the signal from a BTS 180. As a result, the coverage area that a modem can receive a signal successfully from a BTS 180 is also decreased. Also, consider that signal loss typically occurs at each cable and component connection. Therefore, in many standard wireless modem configurations, additional signal losses occur from the connection of an antenna (at a customer premise) to a RF cable, the connection from the RF cable to a jumper cable for the internal/external modem, and the connection from the jumper cable to the modem. With the signal losses at the connections added to the loss that occurs at the cable, the signal strength may be reduced to the point where a wireless RF connection with the BTS 180 may not be strong enough to maintain a connection.

To transfer data from the modem 100 to a computer 150 remote from the modem (and typically located inside a customer's house), a data cable 140 is used to connect the modem 100 to the computer 150 inside the house. The data cable 140, preferably in some embodiments, includes multiple wires inside the cable, where a portion of the wires is used to provide the connection from the modem 100 to the computer 150 for data communications and another portion of the wires is used to provide electrical current to the modem from a power source 170 located remote from the modem (and preferably in proximity to the computer 150). In some embodiments, a power over Ethernet (POE) module (“injector”) (not shown in FIG. 1) is used to connect the data cable 140 to a power source 170. As shown in FIG. 1, an AC/DC converter 160 can be used to convert an AC power supply 170 to DC power that is injected into the data cable 140 by the POE injector. In some embodiments, an AC/DC converter 160 is utilized to convert a 110-115V/230 VAC power source to a 48V DC power source, for example.

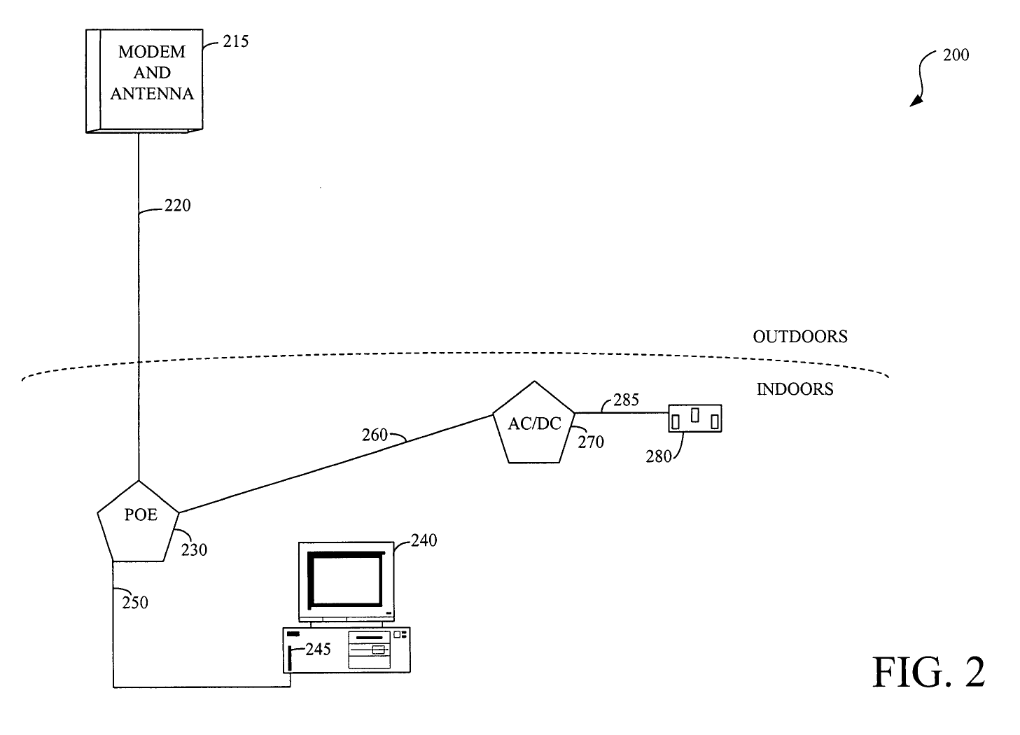

FIG. 2 is a block diagram of one embodiment 200 for implementing a wireless modem according to FIG. 1. In FIG. 2, a modem is directly attached to a high gain antenna 215 that is positioned at a distance from the ground in an outdoor environment (at the customer premise). In some embodiments, the high gain antenna is a panel antenna. A standard network cable 220 (such as CAT5e 568B) is used to provide a data connection and a power connection to the modem 215, as previously described in reference to FIG. 1. The other end of the network cable 220 therefore is connected to a Power over Ethernet (POE) Injector 230 that is located indoors along with a general purpose computer 240 that is in communication with the modem/antenna assembly 215. The POE Injector 230 also preferably includes surge protection capabilities. The Power over Ethernet Injector 230 connects the wires within network cable 220 carrying the data communication from the modem/antenna assembly 215 to a network card 245 of the general purpose computer 240 using standard network cable 250 (such as CAT5e cable with RJ45 jacks). The POE Injector 230 connects the wires within network cable 220 to a DC power source via DC power cord 260. As shown in FIG. 2, an AC/DC converter 270 is used to convert AC power obtained from a standard wall outlet 280 and AC power cord 285 to DC power that is supplied to the Power Over Ethernet Injector 230. For some embodiments, a 115V-230V AC to 48V DC Power converter 270 is used.

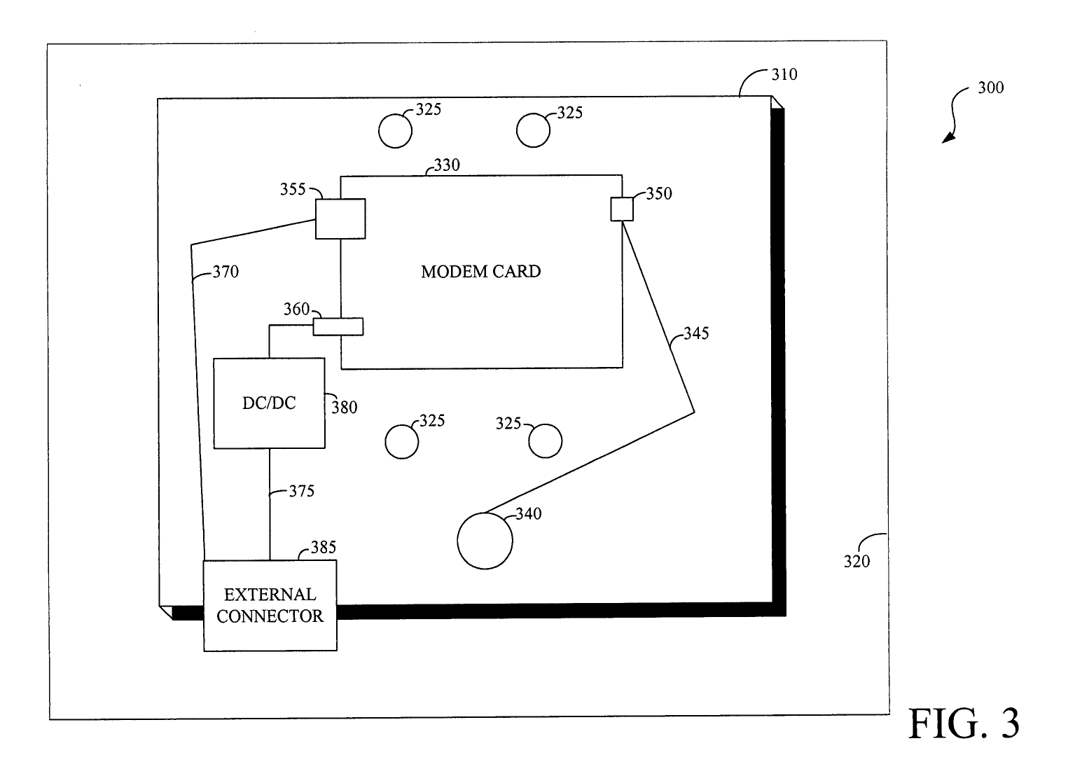

FIG. 3 is a block diagram of the modem/antenna assembly for one embodiment 300 of the disclosure. As shown in FIG. 3, a protective enclosure 310 is attached to the rear of a panel antenna 320. In some embodiments, the protective enclosure 310 is a watertight aluminum die cast enclosure. Mounting bolts 325 are used to attach the watertight enclosure 310 to the rear of panel antenna 320. A modem card 330 with heat sink is mounted inside the watertight enclosure 310. Accordingly, the heat sink dissipates heat produced by the modem card 330 to the outside enclosure 310. An N-female nipple connector 340 on the rear of the panel antenna 320 is used to connect the panel antenna 320 to the modem card 330 using an N-male to MCX-male pigtail jumper 345 (e.g., Hyperlink CA-MCX01—pigtail).

Accordingly, in this embodiment, an MCX Female connector 350 is provided on the modem card 330 for the antenna connection. Also, included on the modem card 330, for this embodiment, is a CAT5e connector 355 (for an internal data connection 370) and an internal DC power connector 360. Correspondingly, a 48V DC to DC converter 380 reduces the 48 Volt DC supplied by the DC power connection 360 to a 5V DC (at 5-8 amps) source (which meets the requirements of the Ethernet range from the POE module and also meets the ampere requirements of licensed and unlicensed spectrum modems), as preferred by the modem card 330 for this embodiment. A watertight CAT5 connector 385, as shown, is provided to connect the internal data and power connections 360, 370 to an external source of data and power connections. As previously described, the external data connection and power connection are provided by disparate groups of wires within a single data cable 140, 220.

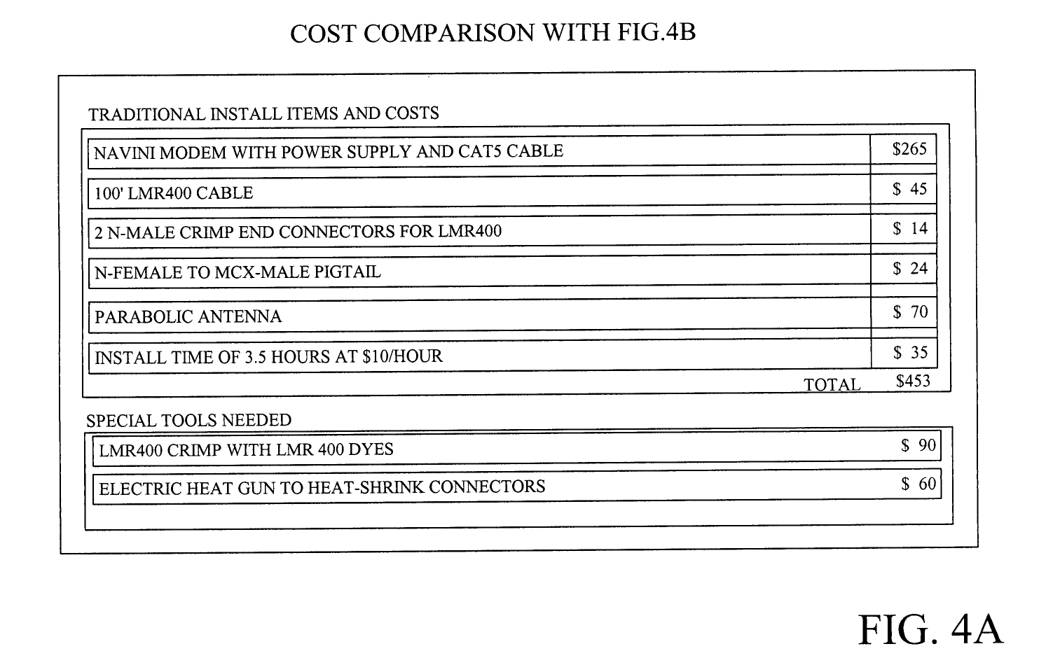

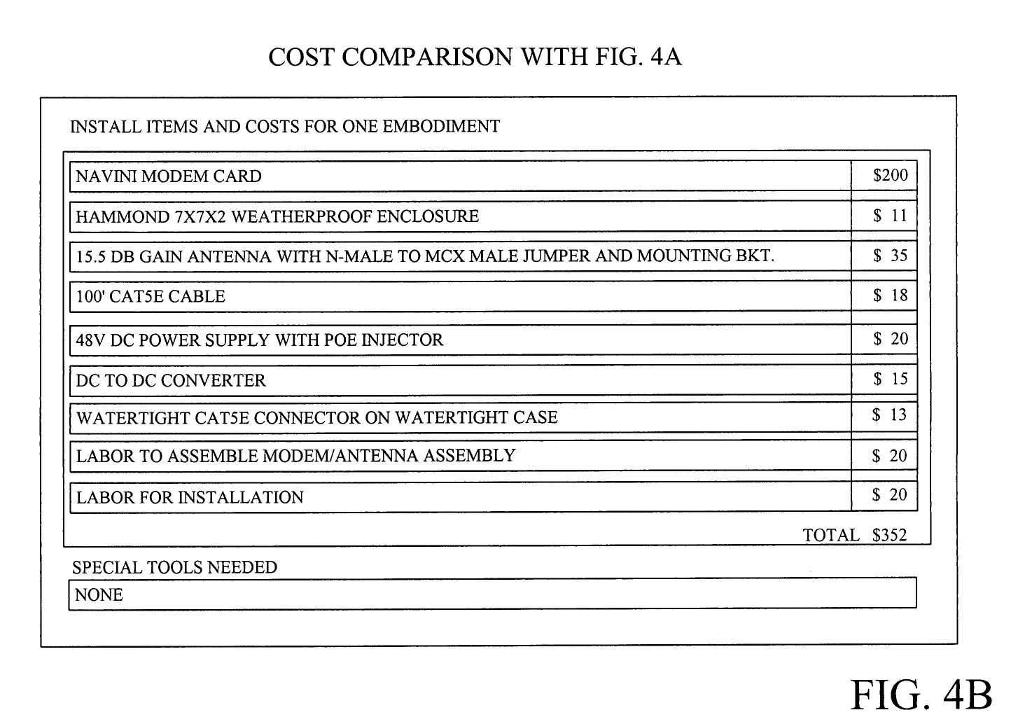

In considering the advantages of the particular approach for implementing a wireless modem described in the present disclosure, FIGS. 4A-4B show a cost comparison between the approach, as described for one embodiment of the present disclosure, and a standard approach. For one standard approach, a parabolic antenna is attached to a tower (e.g., a metal pole) and extended a distance into the air in an outdoor environment. The antenna is connected to a data cable (such as a LMR400 data cable) via an N-type Male Cable with a crimped end. At the other end of the LMR400 data cable, in an indoor environment, an N-female to MCX-Male LMR200 data cable jumper is attached to a N-Type Male Cable (of the LMR400 data cable) with a crimped end. The LMR200 data cable jumper connects the data cable to an external modem (such as a standalone external modem manufactured by Navini™) that is positioned near a general-purpose computer. The modem is connected to a network card of the general-purpose computer by a standard network CAT5e cable with RJ45 jacks. Further, AC power is provided to the general purpose computer via an AC power cord and a standard 115 V AC to 7V DC power converter that is provided to power the wireless modem inside the customer premise.

Accordingly, FIG. 4A shows a table of the costs associated with implementing a wireless modem as described above for one standard approach. As shown, the hardware cost adds up to $453 dollars for the parts included in the table. Further, additional special tools are needed to implement the traditional approach described above. For example, an installer needs an LMR400 crimp tool and a LMR400 stripper tool to complete a traditional or standard install. These tools can cost as much as $300 (total) and can, typically, only be ordered from RF equipment and tool manufacturers.

In comparison, FIG. 4B shows a table of the costs associated with implementing a wireless modem for one embodiment of the present disclosure. Here (and with further references to FIGS. 2-3), a modem card 330 manufactured by Navini™ is mounted to a Hammond™ 7×7×2 box 310 (e.g., Hammond™ 1590F die cast aluminum weatherproof box) to the rear of a 15.5 dB gain panel antenna 320 (e.g., Hyperlink™ HG2416P), as shown in the table. Further, 100 feet of CAT5e cable 220 is used to connect the antenna/modem assembly 215 (from an outdoor environment) to a POE injector 230 (e.g., Current Solutions™ TR60A-POE-L surge protector and POE) located in an indoor environment. (Note, in other implementations, additional cable lengths can be used and thus are not intended to be limited to the 100 feet of CAT5e cable utilized in the above embodiment, e.g., 300 feet of CAT5e cable, among others.) Plus, a DC/DC converter 380 (e.g., Current Solutions™ CHB50-40SO5 48v 5 w 8 Amp) is used inside the metal enclosure 310 and is connected to the modem card 330. Further, a watertight CAT5e connector 385 (e.g., PEIGenesis™ APH RJF544-6, PEIGenesis™ APH RJF544-21, etc.) is provided on the watertight enclosure to connect to the CAT5e cable 220. As shown, the costs of parts and labor for implementing this embodiment of the present disclosure add up to $352 which is distinctly lower than the $453 cost of the traditional approach associated with FIG. 4A. As an added note, the installation time for the approach associated with FIG. 4B is typically on the order of 60% less than the installation time for the standard approach associated with FIG. 4A.

Additional benefits of the approach associated with FIG. 4B (besides the lower cost advantages) include the benefit that the wireless modem approach of FIG. 4B (and other described embodiments) of the present disclosure extends the range of a transmitting base station from a standard transmitting range of 4 miles to an improved transmitting range of 7 miles, for some embodiments. This is due in part to the increased strength of RF signals received by the modem card 330, since cable signal loss is reduced from the antenna 130 (located at customer premise) to the modem device 100, 215, as previously described. Further, a standard wireless modem installation has several connections, which reduces the signal strength and thus, the coverage area for a single distribution tower or BTS 180. For example, if the cumulative gain on an antenna at a customer premise is 24 dB, and there are 5 connection points in the link between a modem and antenna (as in the previously described standard installation associated with FIG. 4A), the associated loss could be as high as 1 dB per connection. Accordingly, a 5 dB loss (due to the several connections) reduces the gain of the antenna at the customer premise to a 19 dB effective range. Since a 3 dB gain represents a doubling of RF signal strength, the elimination of the loss between a wireless modem 100 and is associated antenna 130 the increases the range within which users can connect successfully to a BTS 180.

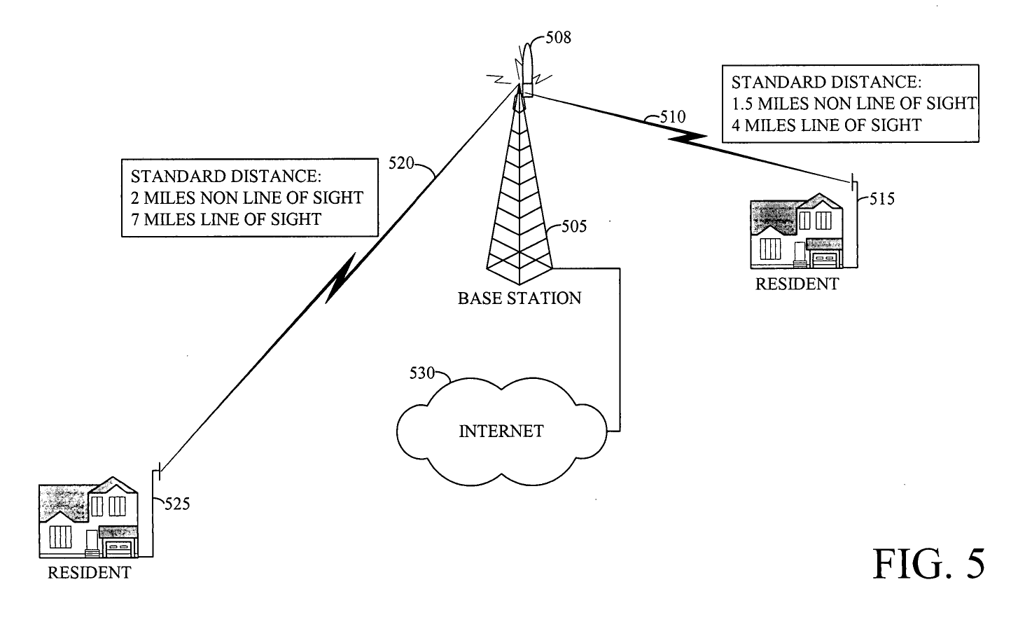

FIG. 5 shows a representation of the increased range of a base terminal station (BTS) that is achieved by utilizing the approaches described in the present disclosure. A transmitting antenna 508 of a BTS 505 is typically several hundred feet in the air. The BTS antenna 508 transmits signals 510, 520 intended to be received by modems that are compatible with the technology of the BTS 505. If a user is sufficiently close in range to the BTS antenna 508, a modem with an indoor antenna (e.g., rabbit ears) may be able to receive the transmitted signals. However, due to foliage and other obstructions, a user or customer may not be able to receive a signal from outside a range of a mile from the BTS antenna 508, for example. Therefore, an outdoor antenna (located at or near a customer premise) is used to receive transmitted signals at farther ranges. As previously explained, use of an outdoor antenna at a customer premise is also limited. Again, foliage and other obstructions limit the strength of a signal that is received by the receiving antenna. Further, signal loss occurs along the length of the data cable between the receiving antenna and the modem. So, if a user's modem is indoors and the receiving antenna is outside on a 40-foot pole, for example, there is 50 or 60 or even 100 feet of cable loss that occurs. As a result, the additional losses (from the RF cable that supplies the received signals to the modem) causes the strength of the signal that is actually received by the modem to be reduced. Correspondingly, the operational or coverage range of the BTS 505 is reduced.

Accordingly, as shown in FIG. 5, a resident or customer employing a standard approach for implementing a wireless modem (as has been previously described) can be expected to establish a network connection with signals 510 transmitted from the BTS 505 (that is connected to the Internet 530) at a distance of 4 miles if the resident's antenna 515 located on or near the customer premise has a clear line of sight with the transmitting antenna at the BTS 505 or 1.5 miles if the resident's antenna 515 does not have a clear line of sight with the BTS antenna 508.

Diversely, with one embodiment of the present disclosure, a resident or customer employing an approach of the present disclosure for implementing a wireless modem can be expected to establish a network connection from signals 520 transmitted from the BTS 505 at least a distance of 7 miles if the resident's antenna 525 (located on or near the customer premise) has a clear line of sight with the base station antenna 505 or 2 miles if the resident's antenna 525 does not have a clear line of sight with the BTS antenna 508. Therefore, the coverage area (where a user can establish a network connection from signals transmitted by the BTS 505) generally doubles by employing the approaches of the present disclosure. Note, a line of sight distance of 9.7 miles has even been observed for a residential antenna located on top of a 50-foot tower for the disclosed approach. This would be a coverage area increase of approximately three times of that achievable with a standard approach. Therefore, a provider of wireless service could possibly meet the service needs of its users in an area without having to build additional BTS units, which are quite expensive. This is especially advantageous for areas (such as rural areas) that are unlikely to have access to multiple BTS units or other manners for receiving fast Internet access.

Additional advantages of embodiments of the present disclosure also include that LMR400 cable is not utilized in the implementation of the wireless modem approach of the present disclosure, for some embodiments. LMR (Land Mobile Radio) cable is known to be difficult to manage/manipulate and must often be special ordered. Further, LMR cable is viewed to be generally aesthetically unappealing. However, standard CAT5e cable, as utilized in the approach associated with FIG. 4B, is easily installed with standard equipment and is easier to run through existing walls and crawl spaces. In addition, LMR400 cable has a limitation of 100 feet between the modem (which is near the computer) and the associated antenna. However, in the approach associated with FIG. 4B, a limitation of 300 feet has been observed between a computer and the associated antenna.

As previously mentioned, by moving a wireless modem 100 in concurrency with its associated antenna 130, there is no line loss that occurs between the modem 100 and the antenna 130. Further, there is also only one connection between the receiving antenna and the modem which also reduces signal loss. Correspondingly, since the strength of the signal received by the modem/antenna assembly 215 of the present disclosure is not appreciably reduced, an aesthetically-pleasing panel antenna can be utilized, instead of a generally aesthetically displeasing parabolic antenna that is used to gain significant coverage in a traditional approach (as associated with FIG. 4A). Additionally, at a decreased cost, this new approach for implementing a wireless modem increases the coverage area of the corresponding BTS by approximately 100 percent (i.e., doubling the coverage area).

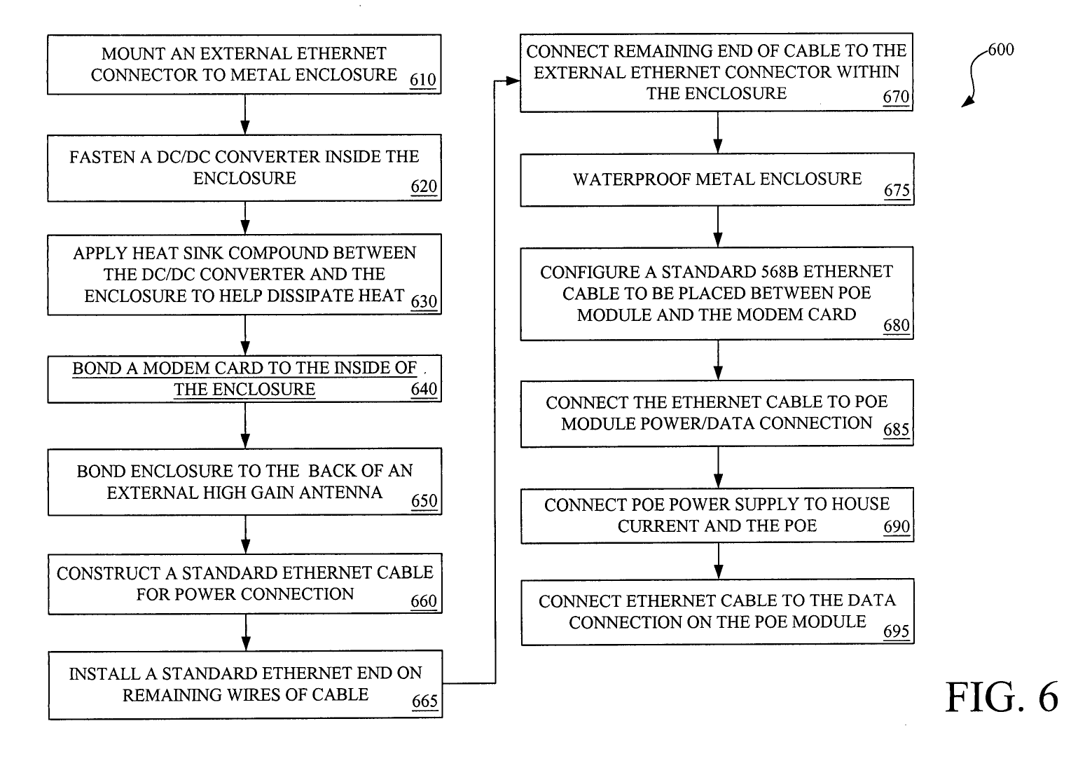

Referring now to the flowchart of FIG. 6, the present disclosure includes one embodiment, among others, of a method 600 for implementing a wireless modem for licensed and unlicensed frequency spectrums. It should be noted that, in some alternative implementations, the functions noted in the various blocks may occur out of the order depicted in the figures. For example, two blocks shown in succession in the figures may, in fact, be executed substantially concurrently or the blocks may be executed in reverse order depending upon the functionality involved.

The process 600 involves drilling one 1/2″ hole and four 1/8″ holes within a metal enclosure in order to mount (610) an external Ethernet connector by using an external Ethernet grommet. Further, four 1/8″ holes are drilled in the top of the metal enclosure in order to fasten (620) a DC/DC converter inside the enclosure. A heat sink compound is used (630) between the DC/DC converter and the enclosure. This allows optimal heat transfer from the DC/DC converter to be dissipated by the enclosure. Accordingly, a modem card is bonded (640) to the inside of the enclosure. The modem card should preferably be positioned to allow easy access to Ethernet, power, and antenna connections within the enclosure without making any kinks or sharp bends in the connections. The enclosure is then bonded (650) to the the back of an external high gain antenna with the correct polarization of the antenna (noting that the external Ethernet connection is positioned at the bottom of the antenna when mounted).

A standard 568B Ethernet cable is constructed (660) with designated pins for power connection. The modem power connector is installed in position to allow for correct DC polarization. Next, a standard CAT5 Ethernet end is installed (665) on the remaining wires following the 568B standard. Accordingly, the remaining end is connected (670) to the external Ethernet connector within the enclosure. The metal enclosure is then waterproofed (675) to prevent water moisture from leaking into the inside of the enclosure. For example, all holes in the enclosure are sealed with caulk during assembly to maintain a watertight enclosure. Further, a thread lock is placed on the DC/DC converter screws and enclosure lid screws. Also, a bead of caulk is placed around the entire base of the enclosure at the antenna.

Next, a standard 568B Ethernet cable is configured (680) to be placed between the POE module and the modem. Accordingly, the Ethernet cable is cut to the desired length, not to exceed the current Ethernet standard. The Ethernet cable is then connected (685) to the POE module power/data connection. Also, the POE power supply is connected (690) to house current and the POE. The end user Ethernet cable is likewise connected (695) to the data connection on the POE module.

Since the modem/antenna assembly 215 of the present disclosure is intended to be positioned in an outdoor environment atop a tall vertical pole, in some embodiments, a variety of measures are contemplated to counteract or manage the potential effects from the environment and adverse conditions. For example, a dessicant compound may be included within the enclosure 110 to absorb potential moisture. A service light observable from the ground may be included on the outside of the enclosure 110 or be positioned at the base of the antenna tower to indicate if a modem malfunction has been detected. Likewise, different sets of LEDs (signal indicators) may also be visible from the ground that indicate signal strength level, for example, so that an installer or user could turn the antenna pole from the ground and judge the signal strength received by the antenna 130. In alternative embodiments, signal indicators may simply be on the outside of the enclosure 110 and not visible from the ground by the naked eye. As previously mentioned, a surge protector component may likewise be built into the POE injector module 230 to protect the modem card 330 and general purpose computer 240 from electrical surges. Correspondingly, the antenna 130 at the customer premise is locally grounded in some preferred embodiments.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A wireless communication system, comprising:
a receiving antenna that receives data signals from a base station; and
a wireless modem co-located with the receiving antenna, the wireless modem receiving the data signals from the receiving antenna and communicating information contained in the data signals to a remote data communications device.

2. The system of claim 1, wherein the receiving antenna and the wireless modem are located in an outdoor environment and the remote computer is located in an indoor environment.

3. The system of claim 1, further comprising:
a protective enclosure protecting the wireless modem from outdoor conditions.

4. The system of claim 3, wherein the protective enclosure comprises a watertight enclosure.

5. The system of claim 4, wherein the receiving antenna comprises a panel antenna.

6. The system of claim 3, wherein the wireless modem comprises a modem card that is bonded to the inside of the protective enclosure.

7. The system of claim 1, wherein the wireless modem is connected to the remote data communications device using a data cable, the data cable including multiple wires, wherein a portion of the multiple wires is used to provide a data connection from the wireless modem to the remote computer and another portion of the multiple wires is used to provide electrical current to the wireless modem from a power source located remotely from the wireless modem.

8. The system of claim 1, wherein a link between the wireless modem and the receiving antenna includes a single data connection.

9. The system of claim 7, wherein substantially no line loss occurs in the link between the wireless modem and the receiving antenna.

10. The system of claim 1, further comprising:
material placed inside the protective enclosure to absorb potential moisture.

11. The system of claim 1, further comprising:
a warning system positioned on an exterior side of the protective enclosure, the warning system operable to detect and visually indicate if a malfunction has occurred with the wireless modem.

12. The system of claim 1, further comprising:
an indicator system for visibly indicating signal strength level of the receiving antenna, the indicator system observable from outside of the protective enclosure.

13. A method for implementing a wireless communication system, comprising the steps of:
directly connecting a wireless modem to a receiving antenna, the receiving antenna and the wireless modem co-located in an outdoor environment; and
coupling the wireless modem to a data communication device, the data communication being positioned remotely from the receiving antenna and the wireless modem.

14. The method of claim 13, further comprising the step of:
enclosing the wireless modem in a watertight protective enclosure.

15. The method of claim 13, further comprising the step of:
detecting a malfunction in operation of the wireless modem; and
visually indicating that the wireless modem is malfunctioning after detecting the malfunction.

16. The method of claim 13, further comprising the step of:
visually indicating a signal strength of the receiving antenna.

17. The method of claim 13, further comprising the step of:
positioning the wireless modem and the receiving antenna atop a vertical pole.

18. The method of claim 13, wherein the data communication device is coupled to the wireless modem via a data cable having multiple wires, the method further comprising the step of:
supplying electrical power to the wireless modem device via a portion of the multiple wires of the data cable.

19. The method of claim 13, wherein the receiving antenna comprises a panel antenna.

20. The method of claim 13, wherein substantially no line loss occurs in communication link between the wireless modem and the receiving antenna
